(19) United States
(12) Patent Application Publication
(10) Pub. No.: US 2021/0230353 A1
(43) Pub. Date: Jul. 29, 2021

(54) SILICONE-CONTAINING POLYURETHANE RESIN COMPOSITION AND SILICONE-CONTAINING POLYURETHANE RESIN CURED PRODUCT, AND METHOD FOR PRODUCING SILICONE-CONTAINING POLYURETHANE UREA RESIN CURED PRODUCT

(71) Applicants: Yuka AOYAMA, Kumamoto (JP); Keiichiro JURI, Kanagawa (JP); Hitoshi SHIRASAKA, Shizuoka (JP); Mutsuhisa FURUKAWA, Fukuoka (JP)

(72) Inventors: Yuka AOYAMA, Kumamoto (JP); Keiichiro JURI, Kanagawa (JP); Hitoshi SHIRASAKA, Shizuoka (JP); Mutsuhisa FURUKAWA, Fukuoka (JP)

(21) Appl. No.: 17/159,361

(22) Filed: Jan. 27, 2021

(30) Foreign Application Priority Data
Jan. 28, 2020 (JP) 2020-011569

(51) Int. Cl. C08G 18/77; C08G 18/10; C08G 18/83; C08G 18/38; C08G 18/75; C08G 18/76

(52) U.S. Cl. CPC C08G 18/778; C08G 18/10; C08G 18/837; C08G 18/7671; C08G 18/755; C08G 18/7621; C08G 18/3819

(57) ABSTRACT

Provided is a silicone-containing polyurethane resin composition including: an isocyanate group-terminated, NCO-terminated modified silicone prepolymer obtained by allowing a first polyisocyanate to undergo reaction with a modified silicone containing at least one hydroxyl group at a terminal; a silicone oil; and an isocyanate group-terminated, NCO-terminated urethane prepolymer obtained by allowing a second polyisocyanate to undergo reaction with polyol, wherein reactivity of the first polyisocyanate with a curing agent is higher than reactivity of the second polyisocyanate with a curing agent.

### CROSS-REFERENCE TO RELATED APPLICATIONS

The present application claims priority under 35 U.S.C. § 119 to Japanese Patent Application No. 2020-011569 filed Jan. 28, 2020. The contents of which are incorporated herein by reference in their entirety.

### BACKGROUND OF THE INVENTION

### Field of the Invention

The present disclosure relates to a silicone-containing polyurethane resin composition and a silicone-containing polyurethane resin cured product, and a method for producing a silicone-containing polyurethane urea resin cured product.

### Description of the Related Art

Organopolysiloxanes (silicones) have unique properties such as surface activity and gas permeability. Various attempts have been proposed to incorporate these properties into polyurethane/urea that is excellent in mechanical properties such as strength and wear resistance.

Because polyurethane/urea resins have a high polarity, polyurethane/urea resins have a poor compatibility with silicones having a low polarity. Therefore, silicones bleed out from polyurethane/urea resins if simply added in the polyurethane/urea resins, and improvement of compatibility has been the key point of focus in overcoming the problem.

For example, a proposed cleaning blade is formed by molding a polyurethane rubber containing a polysiloxane oil having a predetermined viscosity (see Japanese Unexamined Patent Application Publication No. 57-201276).

Meanwhile, silicone manufacturers sell various modified silicone oils for resin reformation used for reforming various resins with silicones. For reformation of polyurethane resins, silicone manufacturers introduce silicones into which a hydroxyl group is incorporated at a terminal of a molecule thereof, and many patents using such products have been proposed.

For example, a proposed cleaning blade is formed by molding a polyurethane rubber containing a modified polysiloxane oil having reactivity (see Japanese Unexamined Patent Application Publication No. 57-201277).

A proposed patent uses a modified silicone resin into which polyester is incorporated from a reactive group at a terminal of the modified silicone oil, because the modified silicone oil alone cannot have a sufficient compatibility.

For example, a proposed polyurethane resin contains a modified silicone polyurethane prepolymer into which a modified silicone oil is incorporated (see Japanese Patent No. 4193394).

However, common design concepts of the existing silicone-containing polyurethane/urea resin compositions described above is how to compatibilize silicones with polyurethane resin matrices. However, modified silicones are expensive, and resins modified to have an improved compatibility further need to undergo a complicated process step.

According to a technique proposed as a method for stably dispersing, for example, dimethyl silicone oils in resins, silicone oils are encapsulated with matrices formed of modified silicone resins. This method is applied to, for example, toners. However, this method needs to use a complicated modified silicone resin as an intermediate body in order to overcome the problem of compatibility.

### SUMMARY OF THE INVENTION

According to an aspect of the present disclosure, provided is a silicone-containing polyurethane resin composition containing: an isocyanate group-terminated, NCO-terminated modified silicone prepolymer obtained by allowing a first polyisocyanate to undergo reaction with a modified silicone containing at least one hydroxyl group at a terminal; a silicone oil; and an isocyanate group-terminated,

NCO-terminated urethane prepolymer obtained by allowing a second polyisocyanate to undergo reaction with polyol, wherein reactivity of the first polyisocyanate with a curing agent is higher than reactivity of the second polyisocyanate with a curing agent.

### BRIEF DESCRIPTION OF THE DRAWINGS

FIG. 1 is a microscopic image of a cross-section of a centrifugated sheet of Example 1.

### DESCRIPTION OF THE EMBODIMENTS

### (Silicone-Containing Polyurethane Resin Composition)

A feature of the present disclosure is that a silicone is dispersed in a polyurethane resin in a phase-separated state, instead of being compatibilized with the polyurethane resin. The present disclosure provides a silicone-containing polyurethane resin composition in which an expensive modified silicone oil is used in a minimum possible amount and an inexpensive unmodified commonly-available silicone oil (e.g., polydimethyl siloxane) is used in a manner that the silicone oil is prevented from bleed.

The present disclosure has an object to provide a method for producing a silicone-containing polyurethane resin composition and a silicone-containing polyurethane resin cured product, and a silicone-containing polyurethane urea resin cured product, wherein the method can inexpensively and easily produce a polyurethane resin that stably contains a silicone.

The present disclosure can provide a method for producing a silicone-containing polyurethane resin composition and a silicone-containing polyurethane resin cured product, and a silicone-containing polyurethane urea resin cured product, wherein the method can inexpensively and easily produce a polyurethane resin that stably contains a silicone.

Specifically, the polyurethane resin composition of the present disclosure contains: an isocyanate group-terminated, NCO-terminated modified silicone prepolymer obtained by allowing a first polyisocyanate to undergo reaction with a modified silicone containing at least one hydroxyl group at a terminal; a silicone oil; and an isocyanate group-terminated, NCO-terminated urethane prepolymer obtained by allowing a second polyisocyanate to undergo reaction with polyol, wherein reactivity of the first polyisocyanate with a curing agent is higher than reactivity of the second polyisocyanate with a curing agent. Hence, it is possible to relatively easily produce a core-shell structure in which the silicone oil constitutes the core and a reacted cured product of the NCO-terminated modified silicone prepolymer and the curing agent constitutes the shell, and to inexpensively and easily obtain a polyurethane resin cured product stably containing a silicone.

A silicone-containing polyurethane resin cured product of the present disclosure contains: an isocyanate group-terminated, NCO-terminated modified silicone prepolymer obtained by allowing a first polyisocyanate to undergo reaction with a modified silicone containing at least one hydroxyl group at a terminal; a silicone oil; an isocyanate group-terminated, NCO-terminated urethane prepolymer obtained by allowing a second polyisocyanate to undergo reaction with polyol; and a curing agent formed of an active hydrogen compound. The silicone-containing polyurethane resin cured product of the present disclosure contains a silicone in a stable state because a core-shell structure in which the silicone oil constitutes the core and a reacted cured product of the NCO-terminated modified silicone prepolymer and the curing agent constitutes the shell is dispersed in a matrix formed of a reacted cured product of the NCO-terminated urethane prepolymer and the curing agent.

A method for producing a silicone-containing polyurethane urea resin cured product of the present disclosure adds a diamine as a curing agent to a silicone-containing polyurethane resin composition to cure the silicone-containing polyurethane resin composition, wherein the silicone-containing polyurethane resin composition contains: an isocyanate group-terminated, NCO-terminated modified silicone prepolymer obtained by allowing a first polyisocyanate to undergo reaction with a modified silicone containing at least one hydroxyl group at a terminal; a silicone oil; and an isocyanate group-terminated, NCO-terminated urethane prepolymer obtained by allowing a second polyisocyanate to undergo reaction with polyol, wherein reactivity of the first polyisocyanate with the curing agent is higher than reactivity of the second polyisocyanate with the curing agent, and wherein the silicone oil is emulsified in the NCO-terminated urethane prepolymer with the NCO-terminated modified silicone prepolymer serving as a surfactant. Hence, it is possible to relatively easily produce a core-shell structure in which the silicone oil constitutes the core and a reacted cured product of the NCO-terminated modified silicone prepolymer and the curing agent constitutes the shell, and to inexpensively and easily obtain a polyurethane resin cured product stably containing a silicone.

The silicone-containing polyurethane resin composition of the present disclosure is a first composition containing the components A, B, and C below.

A. Isocyanate group-terminated, NCO-terminated modified silicone prepolymer obtained by allowing a first polyisocyanate to undergo reaction with a modified silicone containing at least one hydroxyl group at a terminal

B. Silicone oil

C. Isocyanate group-terminated, NCO-terminated urethane prepolymer obtained by allowing a second polyisocyanate to undergo reaction with polyol

### <A. NCO-Terminated Modified Silicone Prepolymer>

The NCO-terminated modified silicone prepolymer is an isocyanate group-terminated prepolymer obtained by allowing a first polyisocyanate to undergo reaction with a modified silicone containing at least one hydroxyl group at a terminal.

The modified silicone is a silicone containing at least one hydroxyl group at a terminal. A commercially available product may be used as the modified silicone.

The modified silicone used in the present disclosure is selected from modified silicones that can form a prepolymer containing an NCO group at a terminal through reaction with the first polyisocyanate. Specific examples of the modified silicone include modified silicones containing a hydroxyl group or an amino group at a terminal, and hydroxyl group-modified silicone is more preferable in terms of stability.

Examples of commercially available products of the modified silicone include KF-6000, K-F-6001, KF-6002, KF-6003, X-22-176F, X-22-176DX, and X-22-176GX-A (all available from Shin-Etsu Silicone Co., Ltd.). Examples of the kinds of terminal modification include modification of one terminal, modification of both terminals, and modification of a side chain. Modification of one terminal is more preferable in terms of efficiency when the modified silicone serves as a surfactant as described below.

The first polyisocyanate is a compound that bonds with a terminal of the modified silicone via urethane bonding to modify the terminal to an isocyanate group (NCO). The details will be described below.

The NCO-terminated modified silicone prepolymer is a silicone prepolymer containing an NCO group at a terminal, and obtained by allowing the first polyisocyanate to undergo reaction with the modified silicone. It is possible to obtain the NCO-terminated modified silicone prepolymer by mixing with the modified silicone, the first polyisocyanate in an amount approximately double the equivalent amount of the functional group of the modified silicone, and heating and stirring the resultant.

### <B. Silicone Oil>

The silicone oil used in the present disclosure is a silicone oil (organopolysiloxane) that is liquid at normal temperature. A commercially available product may be used as the silicone oil.

A common polyorganosiloxane can be used as the silicone oil. In the present disclosure, a silicone oil having a poor compatibility with a polyurethane/urea matrix is more preferable in order to be stably dispersed in the matrix. Such a silicone oil is dispersed in an emulsified state in the NCO-terminated urethane prepolymer with the NCO-terminated modified silicone prepolymer serving as a surfactant. Dimethyl silicone is the most preferable. A dimethyl silicone oil is the most versatile silicone oil, and commercially available dimethyl silicone oils of various manufacturers may be used. A dimethyl silicone oil having a viscosity of from 1 mPa·s through 10,000 mPa·s at 25 degrees C. is preferable because a higher viscosity needs a higher energy during emulsification described above.

### <C. NCO-Terminated Urethane Prepolymer>

The NCO-terminated urethane prepolymer used in the present disclosure is an isocyanate group-terminated prepolymer obtained by allowing a second polyisocyanate to undergo reaction with polyol.

The polyol is a polyol having a molecular weight of from 500 through 4,000, and is a so-called long-chain polyol used in production of polyurethane resins Polyester polyols, polyether polyols, and polycarbonate polyols are preferable.

The second polyisocyanate is a compound that reacts with a hydroxyl group at a terminal of the polyol and bonds with the polyol via urethane bonding, to modify the terminal of the polyol to an isocyanate group (NCO).

Examples of the polyisocyanate compound used as the first polyisocyanate and the second polyisocyanate in the present disclosure include m-phenylene diisocyanate, p-phenylene diisocyanate, 2,4-tolylene diisocyanate, 2,6-tolylene diisocyanate, naphthalene-1,4-diisocyanate, diphenylmethane-4,4′-diisocyanate, 3,3′-methoxy-4,4′-diphenyl diisocyanate, 3,3′-dimethyl diphenylmethane-4,4′-diisocyanate, xylylene-1,4-diisocyanate, 4,4′-diphenylpropane diisocyanate, hexamethylene diisocyanate, 3-isocyanate methyl-3,5,5-trimethyl cyclohexyl isocyanate, dicyclohexylmethane 4,4′-diisocyanate, cyclohexylene-1,2-diisocyanate, and cyclohexylene-1,4-diisocyanate.

The first polyisocyanate and the second polyisocyanate are selected in a manner that reactivity of the first polyisocyanate with a curing agent is higher than reactivity of the second polyisocyanate with a curing agent. An isocyanate group (R-NCO) has a higher reactivity as the substituent R has a higher electron withdrawability. Specifically, reactivity of aromatic polyisocyanates is higher than reactivity of aliphatic polyisocyanates, and reactivity degrades due to steric hindrance of, for example, a methyl group of an inclined chain. These matters can be analogized from the following documents relating to urethanes.
Hepburn, C., Polyurethane Elastomers, Applied Science Publishers, 1982
J. H. Saunders, Frisch K. C., Polyurethanes: Chemistry and Technology, Part 1. Chemistry, 170, Interscience Publishers, New York, 1962
Keiji Iwata, Polyurethane Resin Handbook, Nikkan Kogyo Shimbun, 1987
Yoshiaki Takanaka, Curing Agents for Polyurethane Resin Coatings, 49, Journal of Japan Society of Colour Material, 1976

Generally, reactivity of aromatic polyisocyanates with a curing agent is higher than reactivity of aliphatic or alicyclic polyisocyanates with a curing agent. Therefore, for example, an aromatic polyisocyanate may be selected as the first polyisocyanate, and an aliphatic or alicyclic polyisocyanate may be selected as the second polyisocyanate. However, the first polyisocyanate and the second polyisocyanate may both be aromatic polyisocyanates, or may both be aliphatic or alicyclic polyisocyanates.

Specifically, for example, an aromatic polyisocyanate may be used as the first polyisocyanate, and an aliphatic polyisocyanate may be used as the second polyisocyanate. Alternatively, the first polyisocyanate and the second polyisocyanate may both be selected from either aromatic polyisocyanates or aliphatic polyisocyanates. Examples of such combinations include a combination of xylylene diisocyanate (aliphatic series with a high reactivity) as the first polyisocyanate and dicyclohexylmethane 4,4′-diisocyanate (aliphatic series with a low reactivity) as the second polyisocyanate.

The NCO-terminated urethane prepolymer is the main component that constitutes the matrix of the urethane resin cured product. The NCO-terminated urethane prepolymer may be appropriately synthesized depending on the intended physical properties, or may be selected from commercially available products. For example, it is possible to produce the NCO-terminated urethane prepolymer by mixing a long-chain polyol such as a polyester polyol, a polyether polyol, or a polycarbonate polyol having a molecular weight of from 500 through 4,000 with the second polyisocyanate in an amount approximately double the equivalent amount of the hydroxyl group of the polyol, and heating and stirring the resultant. The NCO-terminated urethane prepolymer may be selected from commercially available products that satisfy the relative reactivity requirement with respect to the first polyisocyanate of the NCO-terminated modified silicone prepolymer.

The first composition of the present disclosure contains the components A, B, and C, which become an emulsified state when mixed. That is, the NCO-terminated modified silicone prepolymer as the component A serves as a surfactant and can retain the silicone oil as the component B in an emulsified state in the NCO-terminated urethane prepolymer as the component C. That is, the NCO-terminated modified silicone prepolymer coordinates around the particles of the silicone oil to form micelles, and the micelles are dispersed in the NCO-terminated urethane prepolymer to form an emulsion.

As described above, the first composition may be an emulsion in which the NCO-terminated modified silicone prepolymer and the silicone oil are dispersed in the NCO-terminated urethane prepolymer. As the disperser, common emulsifying devices such as a high-speed stirrer and a homogenizer may be used.

It is possible to quickly produce a uniformly opalescent dispersion liquid by dispersing the silicone oil after dispersing the NCO-terminated modified silicone prepolymer in the NCO-terminated urethane prepolymer.

The second composition of the present disclosure is addition of a curing agent formed of an active hydrogen compound in the first composition that is in an emulsified state.

The curing agent is an active hydrogen-containing compound having reactivity with an NCO group. Specifically, the curing agent is polyamine or a polyvalent hydroxy compound. When a polyvalent hydroxy compound is used as the curing agent, the matrix resin becomes a polyurethane resin. When polyamine is used as the curing agent, the matrix resin becomes a polyurethane urea resin. In the present disclosure, it is more preferable to use a curing agent containing polyamine in an amount higher than or equal to the equivalent amount of NCO of the silicone prepolymer, because it is effective to accelerate reaction between the NCO-terminated silicone prepolymer and the curing agent that constitute a shell. The polyvalent hydroxy compound serving as a chain extender may be used together with polyamine. It is also possible to use a known urethane curing catalyst (e.g., amines and organic metals) in combination in order to appropriately promote a curing reaction.

An aliphatic polyvalent alcohol is suitably used as the polyvalent hydroxy compound. Examples of aliphatic polyvalent alcohols include ethylene glycol, 1,3-propanediol, 1,4-butanediol, 1,5-pentanediol, 1,6-hexanediol, 1,7-heptanediol, 1,8-octanediol, 1,4-cyclohexanedimethanol, 1,4-bis(hydroxyethoxy)benzene, and 1,3-bis(hydroxyethoxy)benzene.

Examples of polyamine compounds include 4,4′-methylene bis(2-chloroaniline), diethyl toluene diamine, and dimethyl thio toluene diamine.

The second composition becomes a polyurethane/urea resin cured product when thermally set in, for example, a predetermined molding die.

The second composition of the present disclosure contains the NCO-terminated modified silicone prepolymer, an NCO-terminated urethane prepolymer, and a curing agent, which is an active hydrogen-containing compound having reactivity with an NCO group. Therefore, the second composition becomes a polyurethane resin cured product through reaction between a NCO group and the curing agent.

The first polyisocyanate added at a terminal of the NCO-terminated modified silicone prepolymer and the second polyisocyanate added at a terminal of the NCO-terminated urethane prepolymer are selected in a manner that reactivity of the first polyisocyanate with the curing agent is higher than reactivity of the second polyisocyanate with the curing agent. Therefore, the NCO-terminated modified silicone prepolymer forming the micelles first reacts with the curing agent and the silicone oil forms a core, to produce a core-shell structure in which the cured product of the NCO-terminated modified silicone prepolymer constitutes a shell. That is, when the NCO-terminated modified silicone prepolymer forming the micelles first reacts with the curing agent, pseudo-capsules in which the silicone oil is immobilized in the micelles are produced. Subsequently, the NCO-terminated urethane prepolymer that is to constitute the matrix cures through reaction with the curing agent. Therefore, a urethane resin cured product in a state that the core-shell structures are stably dispersed in the urethane/urea matrix is obtained.

### Examples

The present disclosure will be described below by way of Examples. The present disclosure should not be construed as being limited to these Examples.

### (NCO-Terminated Urethane Prepolymer Production Example 1)

A commercially available polyether polyol (polytetramethylene ether glycol (PTMG) with a hydroxyl value of 112, PTG1000, obtained from Mitsubishi Chemical Corporation) (1,000 g) and a commercially available aliphatic diisocyanate (isophorone diisocyanate (IPDI), DISMODULE I, obtained from Sumika Covestro Urethane Co., Ltd.) (444 g) were allowed to undergo reaction together with a tin catalyst, dibutyl tin dilaurylate (0.01 g) at 80 degrees C. for 90 minutes, to obtain an NCO-terminated urethane prepolymer C1 having an IPDI-derived aliphatic isocyanate content of 5.8%.

### (NCO-Terminated Urethane Prepolymer Production Example 2)

An NCO-terminated urethane prepolymer C2 (NCO=5.5%) was obtained in the same manner as in the production example 1, except that a commercially available aliphatic diisocyanate (dicyclohexylmethane 4,4′-diisocyanate (hydrogenated MDI), DISMODULE W, obtained from Sumika Covestro Urethane Co., Ltd.) (524 g) was used instead of IPDI as the second polyisocyanate.

### (NCO-Terminated Urethane Prepolymer Comparative Production Example 3)

An NCO-terminated urethane prepolymer C3 (NCO=6.3%) was obtained in the same manner as in the production example 1, except that a commercially available aromatic cliisocyanate (toluene cliisocyanate (TDI), T-100, obtained from Tosoh Corporation) (350 g) was used instead of IPDI as the second polyisocyanate and no catalyst was used.

### (NCO-Terminated Modified Silicone Prepolymer Production Example 1)

A commercially available aromatic diisocyanate (toluene diisocyanate (TDI), T-100, obtained from Tosoh Corporation) (10.9 g) was allowed to undergo reaction with a commercially available hydroxyl group-modified silicone oil with a hydroxyl value of 35 (X-22-176DX, obtained from Shin-Etsu Silicone Co., Ltd.) (100 g) at 60 degrees C. for 90 minutes, to obtain an NCO-terminated modified silicone prepolymer A1 containing a TDI-derived aromatic isocyanate (NCO=2.4%).

### (NCO-Terminated Modified Silicone Prepolymer Production Example 2)

An NCO-terminated modified silicone prepolymer A2 containing an MDI-derived aromatic isocyanate (NCO=2.3%) was obtained in the same manner as in the production example 1, except that a commercially available aromatic diisocyanate (diphenylmethane diisocyanate (diphenylmethane diisocyanate (MDI), MILLIONATE MT, obtained from Tosoh Corporation) (15.7 g) was used instead of TDI as the first polyisocyanate.

### (NCO-Terminated Modified Silicone Prepolymer Comparative Production Example 3)

An NCO-terminated modified silicone prepolymer A3 containing an IPDI-derived aliphatic isocyanate (NCO=2.3%) was obtained in the same manner as in the production example 1, except that a commercially available aliphatic diisocyanate (isophorone diisocyanate (PIDI), DISMODULE I, obtained from Sumika Covestro Urethane Co., Ltd.) (14 g) was used instead of TDI as the first polyisocyanate.

### (First Composition Production Example 1)

The NCO-terminated urethane prepolymer C1 (98 g), the NCO-terminated modified silicone prepolymer A1 (2 g), and a commercially available dimethyl siloxane oil (KF-96, 1000 cs, obtained from Shin-Etsu Silicone Co., Ltd.) (3 g) were added together and stirred with a homogenizer at 15,000 rpm for 5 minutes, to obtain a silicone oil-emulsified first composition D1 (NCO=5.6%).

### (First Composition Production Example 2)

The NCO-terminated urethane prepolymer C2 (98 g), the NCO-terminated modified silicone prepolymer A2 (2 g), and a commercially available dimethyl siloxane oil (KF-96, 1000 cs, obtained from Shin Etsu Silicone Co., Ltd.) (5 g) were added together and stirred with a homogenizer at 15,000 rpm for 5 minutes, to obtain a silicone oil-emulsified first composition D2 (NCO=5.3%).

### (First Composition Comparative Production Example 3)

A comparative first composition D3 (NCO=5.5%) was obtained in the same manner as in the production example 1, except that a terminally hydroxyl group-modified silicone oil that was not prepolymerized (X-22-176DX, obtained from Shin-Etsu Silicone Co., Ltd.) was used as is instead of the NCO-terminated modified silicone prepolymer A1.

### (First Composition Comparative Production Example 4)

The NCO-terminated urethane prepolymer C1 (98 g), the NCO-terminated modified silicone prepolymer A3 (2 g), and a commercially available dimethyl siloxane oil (KF-96, 1000 cs, obtained from Shin-Etsu Silicone Co., Ltd.) (3 g) were added together and stirred with a homogenizer at 15,000 rpm for 5 minutes, to obtain a silicone oil-emulsified comparative first composition D4 (NCO=5.6%).

### (First Composition Comparative Production Example 5)

The NCO-terminated urethane prepolymer C3 (98 g), the NCO-terminated modified silicone prepolymer A1 (2 g), and a commercially available dimethyl siloxane oil (KF-96, 1000 cs, obtained from Shin-Etsu Silicone Co., Ltd.) (3 g) were added together and stirred with a homogenizer at 15,000 rpm for 5 minutes, to obtain a silicone oil-emulsified comparative first composition D5 (NCO=6.0%).

### Example 1

Diethyl tolylene diamine (DETDA, ETACURE 100, obtained from Mitsui Fine Chemicals, Inc.) (10.9 g) serving as a curing agent was added in the silicone oil-emulsified first composition D1 (103 g) heated to 80 degrees C., and the resultant was injected into a centrifugal drum (with an internal diameter of 180 mm, 1,800 rpm) heated to 100 degrees C. and allowed to undergo reaction for 30 minutes, to obtain a silicone-containing polyurethane urea cured product (with a hardness of 95 degrees by a durometer/IRDH harness meter).

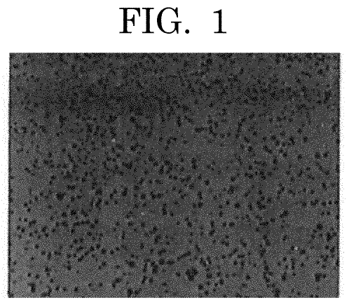

The obtained cured product was opalescent and semi-transparent, and no bleed of the silicone oil was observed on the surface thereof. FIG. 1 is a microscopic image of a cross-section of a centrifugated sheet. Although the sheet was centrifugally molded, the silicone having a low specific gravity was dispersed uniformly. The average particle diameter was 0.74 micrometers.

This is inferred as follows. Because reactivity of the NCO-terminated modified silicone prepolymer A1 containing a TDI-derived aromatic isocyanate and emulsifying the silicone oil was faster than reactivity of the IPDI-derived aliphatic isocyanate at the terminal of the NCO-terminated urethane prepolymer C1, the silicone oil was immobilized by the cured product of the NCO-terminated modified silicone prepolymer without the emulsified state broken, and pseudo-capsules in which the silicone oil was immobilized in micelles were produced. Subsequently, the NCO-terminated urethane prepolymer that was to constitute the matrix cured through reaction with the curing agent. As a result, a urethane resin cured product in which the core-shell structures were stably dispersed in the urethane/urea matrix was obtained.

A polyurethane urea molding with a silicone finely dispersed at a high concentration, which hitherto has needed a complicated intermediate body and process step, can be produced with the use of a surfactant having a relatively high reactivity compared with the matrix.

### Example 2

The same process as in Example 1 was performed except that the first composition D2 (103 g) was used instead of the first composition D1, and a mixture of 3,5-bis(methylthio)-2,6-toluene diamine and 3,5-bis(methylthio)-2,4-toluene diamine (DMTDA, ETACURE 300, obtained from Mitsui Fine Chemicals, Inc.) (12.4 g) was used instead of ETACURE 100 as a curing agent.

The obtained cured product was opalescent and semi-transparent, and no bleed of the silicone oil was observed on the surface thereof.

### Comparative Example 1

The same process as in Example 1 was performed except that the first composition D3 was used instead of the first composition D1.

The obtained cured product was opalescent and semi-transparent, and bleed of the silicone oil was observed on the surface thereof.

### Comparative Example 2

The same process as in Example 1 was performed except that the first composition D4 was used instead of the first composition D1 and ETACURE 100 (11.0 g) was used as a curing agent.

The obtained cured product was opalescent and semi-transparent, and bleed of the silicone oil was observed on the surface thereof.

### Comparative Example 3

The same process as in Example 1 was performed except that the first composition D5 was used instead of the first composition D1, and a mixture of ETACURE 300 (3,5-bis(methylthio)-2,6-toluene diamine) and 3,5-bis(methylthio)-2,4-toluene diamine (obtained from Mitsui Fine Chemicals, Inc.) (14.2 g) was used instead of ETACURE 100 as a curing agent.

The obtained cured product was opalescent and semi-transparent, and bleed of the silicone oil was observed on the surface thereof.

TABLE 1

| | | | Comp. | Comp. | Comp. |
|---|---|---|---|---|---|
| | Ex. 1 | Ex. 2 | Ex. 1 | Ex. 2 | Ex. 3 |
| Modified | DX-176 | DX-176 | DX-176 | DX-176 | DX-176 |
| silicone | | | | | |
| First | TDI | MDI | — | IPDI | TDI |
| polyisocyanate | | | | | |
| Silicone oil | #1000 | #1000 | #1000 | #1000 | #1000 |
| Polyol | PTG1000 | PTG1000 | PTG1000 | PTG1000 | PTG1000 |
| Second | IPDI | H-MDI | IPDI | IPDI | TDI |
| polyisocyanate | | | | | |
| Curing agent | DETDA | DMTDA | DETDA | DETDA | DMTDA |
| Bleed | Absent: | Absent: | Present: | Present: | Present: |
| | A | A | C | C | B |

Aspects of the present disclosure are, for example, as follows.

<1> A silicone-containing polyurethane resin composition including:

an isocyanate group-terminated, NCO-terminated modified silicone prepolymer obtained by allowing a first polyisocyanate to undergo reaction with a modified silicone containing at least one hydroxyl group at a terminal;

a silicone oil; and

an isocyanate group-terminated, NCO-terminated urethane prepolymer obtained by allowing a second polyisocyanate to undergo reaction with polyol,

wherein reactivity of the first polyisocyanate with a curing agent is higher than reactivity of the second polyisocyanate with a curing agent.

<2> The silicone-containing polyurethane resin composition according to <1>,

wherein the silicone oil is emulsified in the NCO-terminated urethane prepolymer with the NCO-terminated modified silicone prepolymer serving as a surfactant.

<3> The silicone-containing polyurethane resin composition according to <1>, further including

a curing agent formed of an active hydrogen compound.

<4> A silicone-containing polyurethane resin cured product,

wherein the silicone-containing polyurethane resin cured product is obtained by curing the silicone-containing polyurethane resin composition according to <3>.

<5> A silicone-containing polyurethane resin cured product including:

an isocyanate group-terminated, NCO-terminated modified silicone prepolymer obtained by allowing a first polyisocyanate to undergo reaction with a modified silicone containing at least one hydroxyl group at a terminal;

a silicone oil;

an isocyanate group-terminated, NCO-terminated urethane prepolymer obtained by allowing a second polyisocyanate to undergo reaction with polyol; and

a curing agent formed of an active hydrogen compound,

wherein a core-shell structure in which the silicone oil constitutes a core and a reacted cured product of the NCO-terminated modified silicone prepolymer and the curing agent constitutes a shell is dispersed in a matrix formed of a reacted cured product of the NCO-terminated urethane prepolymer and the curing agent.

<6> The silicone-containing polyurethane resin cured product according to <5>,

wherein the first polyisocyanate is an aromatic polyisocyanate,

wherein the second polyisocyanate is an aliphatic polyisocyanate, and

wherein the curing agent is an aromatic amine.

<7> A method for producing a silicone-containing polyurethane urea resin cured product, the method including

adding a diamine as a curing agent to a silicone-containing polyurethane resin composition to cure the silicone-containing polyurethane resin composition,

wherein the silicone-containing polyurethane resin composition includes:

an isocyanate group-terminated, NCO-terminated modified silicone prepolymer obtained by allowing a first polyisocyanate to undergo reaction with a modified silicone containing at least one hydroxyl group at a terminal;

a silicone oil; and

an isocyanate group-terminated, NCO-terminated urethane prepolymer obtained by allowing a second polyisocyanate to undergo reaction with polyol,

wherein reactivity of the first polyisocyanate with the curing agent is higher than reactivity of the second polyisocyanate with the curing agent, and

wherein in the silicone-containing polyurethane resin composition, the silicone oil is emulsified in the NCO-terminated urethane prepolymer with the NCO-terminated modified silicone prepolymer serving as a surfactant.

<8> The method for producing a silicone-containing polyurethane urea resin cured product according to <7>,

wherein the first polyisocyanate is selected from aromatic polyisocyanates,

wherein the second polyisocyanate is selected from aliphatic polyisocyanates, and

wherein the curing agent is selected from aromatic amines.

The silicone-containing polyurethane resin composition according to any one of <1> to <3>, the silicone-containing polyurethane resin cured product according to any one of <4> to <6>, and the method for producing a silicone-containing polyurethane urea resin cured product according to <7> or <8> can solve the various problems in the related art and achieve the object of the present disclosure.

What is claimed is:

1. A silicone-containing polyurethane resin composition comprising:
an isocyanate group-terminated, NCO-terminated modified silicone prepolymer obtained by allowing a first polyisocyanate to undergo reaction with a modified silicone containing at least one hydroxyl group at a terminal;
a silicone oil; and
an isocyanate group-terminated, NCO-terminated urethane prepolymer obtained by allowing a second polyisocyanate to undergo reaction with polyol,
wherein reactivity of the first polyisocyanate with a curing agent is higher than reactivity of the second polyisocyanate with a curing agent.

2. The silicone-containing polyurethane resin composition according to claim 1,
wherein the silicone oil is emulsified in the NCO-terminated urethane prepolymer with the NCO-terminated modified silicone prepolymer serving as a surfactant.

3. The silicone-containing polyurethane resin composition according to claim 1, further comprising
a curing agent formed of an active hydrogen compound.

4. A silicone-containing polyurethane resin cured product,
wherein the silicone-containing polyurethane resin cured product is obtained by curing the silicone-containing polyurethane resin composition according to claim 3.

5. A silicone-containing polyurethane resin cured product comprising:
an isocyanate group-terminated, NCO-terminated modified silicone prepolymer obtained by allowing a first polyisocyanate to undergo reaction with a modified silicone containing at least one hydroxyl group at a terminal;
a silicone oil;
an isocyanate group-terminated, NCO-terminated urethane prepolymer obtained by allowing a second polyisocyanate to undergo reaction with polyol; and
a curing agent formed of an active hydrogen compound,
wherein a core-shell structure in which the silicone oil constitutes a core and a reacted cured product of the NCO-terminated modified silicone prepolymer and the curing agent constitutes a shell is dispersed in a matrix formed of a reacted cured product of the NCO-terminated urethane prepolymer and the curing agent.

6. The silicone-containing polyurethane resin cured product according to claim 5,
wherein the first polyisocyanate is an aromatic polyisocyanate,
wherein the second polyisocyanate is an aliphatic polyisocyanate, and
wherein the curing agent is an aromatic amine.

7. A method for producing a silicone-containing polyurethane urea resin cured product, the method comprising
adding a diamine as a curing agent to a silicone-containing polyurethane resin composition to cure the silicone-containing polyurethane resin composition,
wherein the silicone-containing polyurethane resin composition comprises:
an isocyanate group-terminated, NCO-terminated modified silicone prepolymer obtained by allowing a first polyisocyanate to undergo reaction with a modified silicone containing at least one hydroxyl group at a terminal;
a silicone oil; and
an isocyanate group-terminated, NCO-terminated urethane prepolymer obtained by allowing a second polyisocyanate to undergo reaction with polyol,
wherein reactivity of the first polyisocyanate with the curing agent is higher than reactivity of the second polyisocyanate with the curing agent, and
wherein in the silicone-containing polyurethane resin composition, the silicone oil is emulsified in the NCO-terminated urethane prepolymer with the NCO-terminated modified silicone prepolymer serving as a surfactant.

8. The method for producing a silicone-containing polyurethane urea resin cured product according to claim 7,
wherein the first polyisocyanate is selected from aromatic polyisocyanates,
wherein the second polyisocyanate is selected from aliphatic polyisocyanates, and
wherein the curing agent is selected from aromatic amines.
